(19) United States
(12) Patent Application Publication
(10) Pub. No.: US 2023/0067417 A1
(43) Pub. Date: Mar. 2, 2023

(54) TORSIONAL VIBRATION DAMPER ARRANGEMENT HAVING HUB-INTERNAL CONNECTING ELEMENTS

(71) Applicant: Schaeffler Technologies AG & Co. KG, Herzogenaurach (DE)

(72) Inventor: Gerd Ahnert, Sasbach (DE)

(73) Assignee: Schaeffler Technologies AG & Co. KG, Herzogenaurach (DE)

(21) Appl. No.: 17/893,531

(22) Filed: Aug. 23, 2022

(30) Foreign Application Priority Data
Sep. 2, 2021 (DE) 10 2021 122706.2

(51) Int. Cl. F16H 57/00; F16F 15/12; F16F 15/121

(52) U.S. Cl. CPC F16H 57/0006; F16F 15/1207; F16F 15/1216; F16H 2057/0012; F16F 2230/0005

(57) ABSTRACT

A torsional vibration damper arrangement for a drive train of a motor vehicle includes a torsional vibration damper having an input flange, a first output flange, a second output flange, a hub, a first connecting element, and a second connecting element. The first output flange is rotatable relative to the input flange about an axis of rotation against a spring device. The first connecting element lies on a first radius relative to the axis of rotation and connects the first output flange, the second output flange, and the hub in rotationally fixed and form-fitting or force-fitting manner for torque transmission to a further component. The second connecting element is disposed at least partially radially inside the hub and connects the hub to the second output flange in a force-fitting or form-fitting manner.

### CROSS-REFERENCE TO RELATED APPLICATIONS

This application claims priority under 35 U.S.C. § 119 to German patent application DE 10 2021 122 706.2, filed Sep. 2, 2021, the disclosure of which is incorporated herein by reference.

### TECHNICAL FIELD

The present disclosure relates to a torsional vibration damper arrangement having a torsional vibration damper, e.g., for use in a drive train of a motor vehicle. The torsional vibration damper arrangement is useful in situations where a connection to a shaft via an output flange is necessary.

### BACKGROUND

Depending on the installation situation in a motor vehicle, the internal combustion engine and transmission can be directly connected to one another in a common housing, so that a transmission input shaft is usually connected to the crankshaft of the internal combustion engine via a clutch and possibly a torsional vibration damper. Alternatively, the internal combustion engine and the transmission can be designed to be spatially separated from one another and connected to one another by a shaft, in particular a connecting shaft. Here, the shaft is usually connected via an output flange to a torsional vibration damper, which is connected to the clutch. Due to the spatially separate design of the internal combustion engine and transmission, axial and/or angular offsets can occur, which cause a moment at the connection between the shaft and the output flange. This causes additional forces on the connecting elements through which the output flange is connected to other elements of the torsional vibration damper. These connecting elements are thus subjected to a load and can fail, leading to a reduction in transmissible torque and ultimately to component failure.

### SUMMARY

A torsional vibration damper arrangement according to the disclosure, e.g., for use in a drive train of a motor vehicle, includes a torsional vibration damper having an input flange and at least one first output flange, which can be rotated relative to one another about an axis of rotation against a plurality of spring devices, for example including at least one bow spring. The at least one first output flange is connected via a hub to a second output flange for torque transmission to a further component in a rotationally fixed manner, and the at least one first output flange, the hub and the second output flange are connected in a form-fitting and/or force-fitting manner by at least one first connecting element, which lies on at least one first radius with respect to the axis of rotation. At least one second connecting element connects the hub to the second output flange in a force-fitting and/or form-fitting manner, and the second connecting element is designed to be at least partially radially inside the hub.

Thus, the torsional vibration damper arrangement has an additional second connecting element, which is designed to be radially inside the hub. This installation space is usually free when connecting shafts via an output flange, such as the second output flange in this case, and is used here for the additional second connecting element. If an axial and/or angular offset can be present, this causes a moment which acts on the second output flange via the shaft. This leads to additional forces on the first connecting elements and subjects them to a load, usually in a manner fluctuating over time due to the rotation of the torsional vibration damper arrangement. This can reduce the torque that can be transmitted through the torsional vibration damper and lead to component failure. The second connecting element connects the hub to the second output flange radially on the inside. This applies an additional clamping force which counteracts the adverse bending effect caused by the shaft that can be connected to the second output flange and which at least reduces the additional load on the first connecting elements or even removes it completely.

The second connecting element may be aligned to be flush with the axis of rotation. Second connecting elements may be screws and threads, screws and threaded nuts and/or bolts, which have an axis. This axis may be aligned with the axis of rotation, as the influence on the rotational behavior of the torsional vibration damper arrangement is thus negligible.

The hub may have a largest inner diameter and the second connecting element may extend radially with respect to the axis of rotation within this largest inner diameter. For example, if the second connecting element and the axis of rotation are aligned to be flush, i.e., if the second connecting element is designed to be centrally positioned, the additional clamping force is applied effectively and with low technical expenditure. If the second connecting element extends radially completely inside the hub with respect to the axis of rotation, a compact design of the torsional vibration damper arrangement can be achieved.

Multiple second connecting elements may be designed. This allows for an individual adjustment of the necessary additional clamping force by forming individual combinations of second connecting elements radially inside the hub.

The second connecting element may include a screw and a thread in the second output flange. This allows for a simple structure and mounting of the torsional vibration damper arrangement.

The second connecting element may include a screw and a threaded nut. A design with at least one second connecting element having a threaded nut allows a structure in which the hub and/or two output flanges do not have to be individually adjusted. In this way, a kind of modular kit can be created with individual hubs or hub parts and output flanges that can be adapted to different situations without individual adjustments to the individual components.

The second connecting element may include a spring element for applying an additional clamping force. This can further increase the additional clamping force generated by the second connecting element.

The second connecting element may include a bolt, a locking ring and a spring element for applying an additional clamping force. This allows for easy mounting of the second connecting element.

The spring element may include a disc spring. Such a spring is simple to design and mount.

Furthermore, a motor vehicle is proposed including a connecting shaft and a torsional vibration damper arrangement as proposed herein, wherein the second output flange of the torsional vibration damper arrangement is connected to the connecting shaft in a rotationally fixed manner.

This allows for the construction of drive trains in motor vehicles in which the combustion engine and transmission are designed to be spatially separated from one another. Due to the torsional vibration damper arrangement as proposed here, an axial and/or angular offset does not have a negative effect on the connection between the torsional vibration damper arrangement and the connecting shaft, so that, for example, a cardan shaft can be dispensed with and replaced by a simple connecting shaft.

As a precaution, it should be noted that the numerals used here (“first”, “second”, etc.) serve primarily (only) to distinguish between several similar objects, sizes, or processes, and in particular no necessary dependency and/or sequence of these objects, sizes, or processes to each other is purported. If a dependency and/or sequence is necessary, this is explicitly stated here or results in a manner obvious to the person skilled in the art when studying the specifically described configuration.

### BRIEF DESCRIPTION OF THE DRAWINGS

Both the disclosure and the technical field are explained in more detail below with reference to the figures. It should be noted that the disclosure is not intended to be limited by the exemplary embodiments shown. For example, unless explicitly stated otherwise, it is also possible to extract partial aspects of the substantive matter outlined in the figures and to combine them with other components and knowledge from the present description and/or figures. It should also be noted that the figures and the proportions shown are only schematic. Identical reference symbols indicate the same objects, so that where applicable, explanations from other figures can also be used. In the figures:

FIG. 1 shows an example of a motor vehicle;

FIG. 2 shows a hub arrangement for connecting a torsional vibration damper to a connecting shaft;

FIG. 3 shows a first example of a torsional vibration damper arrangement;

FIG. 4 shows the first example of a torsional vibration damper arrangement having a mounted connecting shaft;

FIG. 5 shows a second example of a torsional vibration damper arrangement having a mounted connecting shaft;

FIG. 6 shows a third example of a torsional vibration damper arrangement having a mounted connecting shaft;

FIG. 7 shows a top view of a fourth example of a torsional vibration damper arrangement without a connecting shaft;

FIG. 8 shows a section through the fourth example of a torsional vibration damper arrangement having a connecting shaft;

FIG. 9 shows a detail of a fifth example of a torsional vibration damper arrangement; and

FIG. 10 shows another sectional view of the second example of a torsional vibration damper arrangement

### DETAILED DESCRIPTION

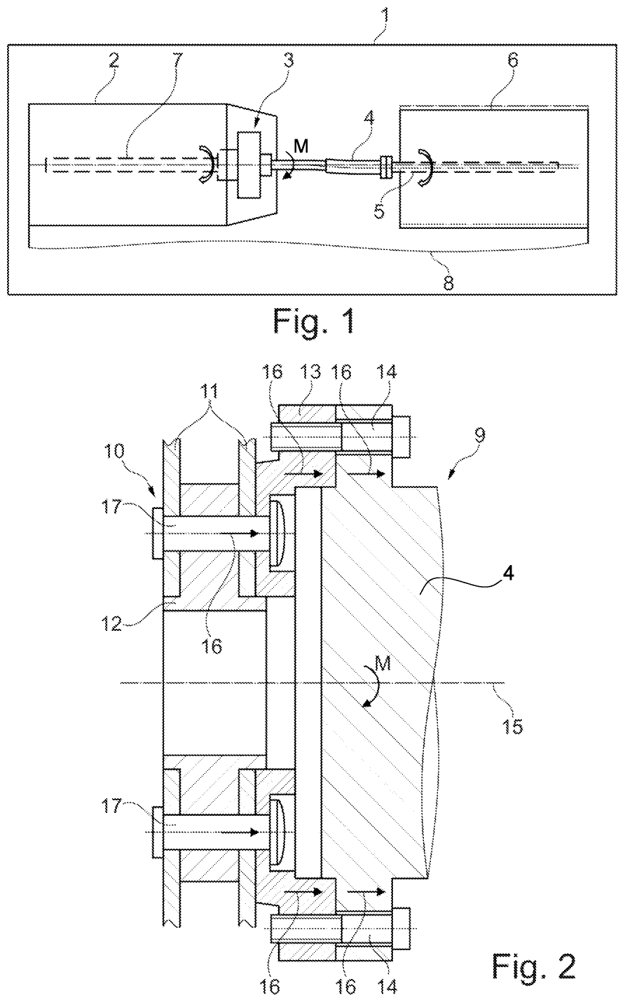

FIG. 1 shows, in a highly schematic fashion, an example of a motor vehicle 1 having an internal combustion engine 2, the crankshaft 7 of which is connected to a transmission input shaft 5 of a transmission 6 via a clutch 3 having a torsional vibration damper not shown here and a connecting shaft 4. The internal combustion engine 2 and transmission 6 are designed to be spaced apart from one another, so that, for example, they do not share a common housing, which defines the alignment of the internal combustion engine 2 and transmission 6 and prevents relative movements between these elements. The internal combustion engine 2 and transmission 6 are jointly connected to a chassis 8 of the motor vehicle 1. This connection, due to the lack of rigidity of the connection between the internal combustion engine 2 and the transmission 6, usually allows relative movements between these elements that lead to the occurrence of a moment M on the connecting shaft 4 and, consequently, on the connection of the connecting shaft 4 to the clutch 3.

FIG. 2 schematically shows a torsional vibration damper arrangement 9 having a torsional vibration damper 10 shown only in a detail. The torsional vibration damper 10 is connected to the clutch 3, which is not shown here. The torsional vibration damper 10 has an input flange not shown here, and two first output flanges 11. The input flange may be connected to the clutch 3.

The first output flanges 11 are designed to be rotatable relative to the input flange against the action of a spring device, not shown here, for damping torsional vibrations about an axis of rotation 15. The first output flanges 11 are connected to a hub 12 and a second output flange 13 in a rotationally fixed manner. A shaft, in this case the connecting shaft 4, is connected via the second output flange 13 by connecting means 14. This makes it possible to transmit torque to an output element, such as the connecting shaft 4 in this case, without this being designed to be inside the hub 12.

Where reference is made in this publication to the terms “axial” and “radial”, these are always understood to relate to the axis of rotation 15, unless otherwise specified.

Due to the moment M, which arises as a result of an angular and/or axial offset between the internal combustion engine 2 and the transmission 6, additional forces 16 act on the torsional vibration damper arrangement 9, e.g., on the first connecting elements 17, via which the at least one first output flange 11, the hub 12 and the second output flange 13 are connected to one another in a form-fitting and/or force-fitting manner in order to transmit torque. These additional forces 16 are axial forces in the direction of the axis of rotation 15.

The forces are subject to a certain periodicity due to the rotation of the torsional vibration damper arrangement 9 in operation, so that the amplitude of the additional force 16 acting on a certain first connecting element 17 is variable in time. Depending on the type of connection, this can have different effects. If, as in this example, a riveted connection is provided, the additional force 16 results in an axial load on the riveted connection. If instead a screw connection is designed as the first connecting element 17, the additional force 16 leads to a reduction of the axial clamping force and thus to a reduction of the possible moment transmission in the respective region. If a pin connection or additional toothing is also designed, the additional force 16 results in a bending load due to the elastic deformation of the components such as the second input flange 13 and hub 12, which can possibly lead to a failure of the first connecting element 17, so that the moment transmission via the torsional vibration damper arrangement 9 is at least reduced.

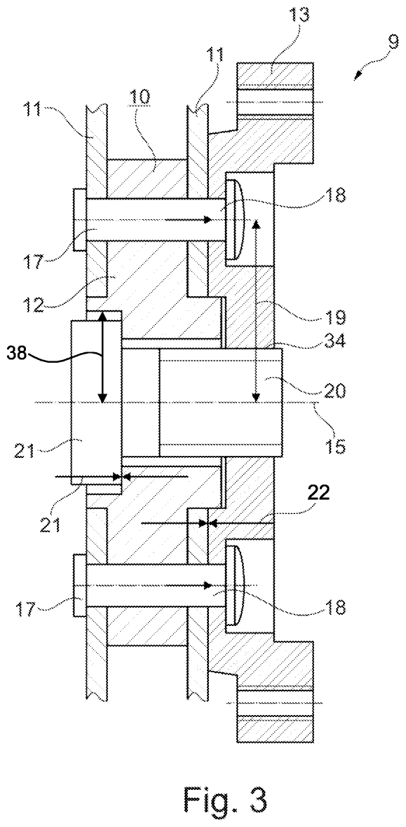

FIG. 3 shows a first example of a torsional vibration damper arrangement 9 having an axis of rotation 15, which has a modified structure compared to the example of FIG. 2. The torsional vibration damper arrangement 9 includes a torsional vibration damper 10 shown only in part, which includes an input flange not shown and two first output flanges 11 and a hub 12. The torsional vibration damper 10 is connected to a second output flange 13 in a rotationally fixed manner. Via the second output flange 13 an output shaft 4 can be connected as an output element, which may be connected to a transmission input shaft of a transmission. The rotationally fixed connection is established between the first output flanges 11, the hub 12 and the second output flange 13 via at least one first connecting element 17, which in this example is designed as a rivet 18. The first connecting elements 17 are arranged radially about the axis of rotation 15 on at least a first radius 19. Through the first connecting elements 17, torque is transmitted during operation of the torsional vibration damper 10 between the input flange, not shown, via the first output flanges 11 and the hub 12, and the second output flange 13, and thus ultimately the connecting shaft 4, without the need for gearing to transmit the torque and without the corresponding shaft extending inside the hub 12.

Furthermore, the torsional vibration damper arrangement 9 includes a second connecting element 20. In the present example, the second connecting element 20 is a screw 21, which is arranged radially inside the hub 12 and whose axis is concentric with the axis of rotation 15. The second connecting element 20 is thus aligned to be flush with the axis of rotation. In this example, the second connecting element 20 is designed to be radially completely inside a largest inner radius 38 of the hub 12. The second connecting means 20 is thus designed to be centrally in the hub 12. This facilitates the design and mounting of the torsional vibration damper arrangement 9. In this example, the screw 21 corresponds to a corresponding thread 34 in the second output flange 13 and causes an axially acting additional clamping force 22, which counteracts the moment M applied to the connecting shaft 4.

This can result in a large first radius 19 and thus a large torque to be transmitted via the torsional vibration damper 10 with a reduction in the additional forces 16 acting on the first connecting elements 13. Alternatively, it is also possible to provide a corresponding thread 34 in the hub 12 and to connect the second connecting means 20 or the screw 21 to the thread from the direction of the second output flange 13,

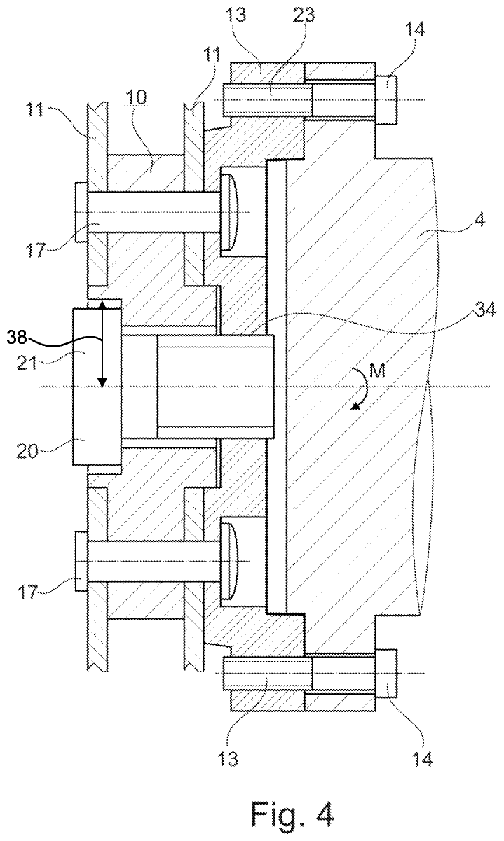

FIG. 4 shows the first example of a torsional vibration damper arrangement 9 having a mounted connecting shaft 4 and applied moment M. Here, connecting means 14 between the second output flange 13 and connecting shaft 4 are designed as screws 23. Even if a corresponding moment M acts on the connecting shaft 4, the additional forces 16 are considerably reduced compared to the situation in FIG. 2. For example, little or no additional force 16 may be applied to the first connecting elements 17.

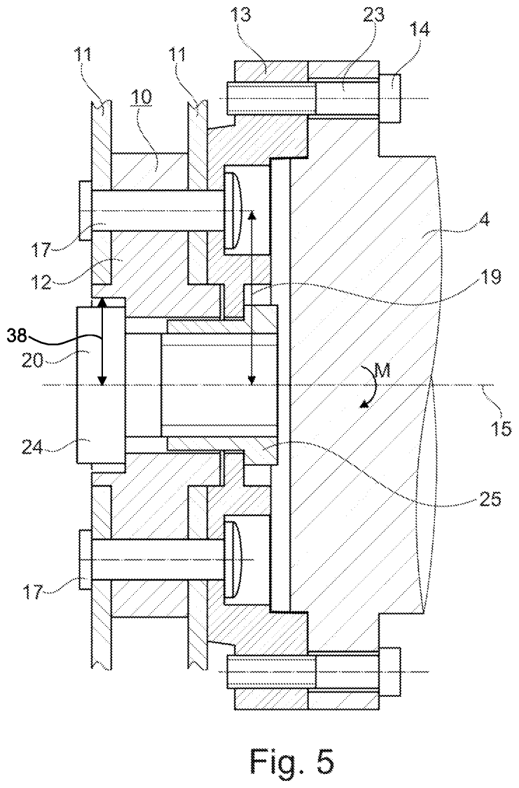

FIG. 5 shows a second example of a torsional vibration damper arrangement 9. In order to avoid repetitions, only the differences to the first example are explained here and, in addition, reference is made to the embodiments for the first example. In contrast to the first example, the second connecting element 20 is designed here as a screw 24 having a separate threaded nut 25. This makes it possible to exchange the screw direction.

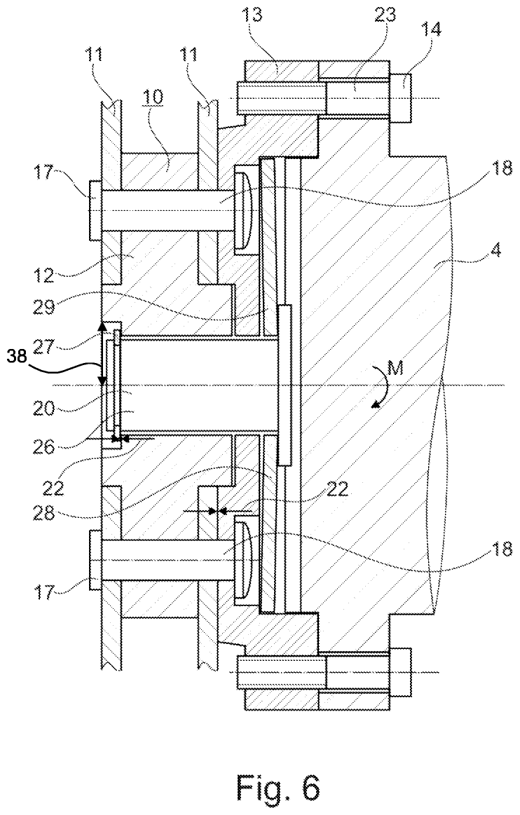

FIG. 6 shows a third example of a torsional vibration damper arrangement 9. In order to avoid repetitions, only the differences to the first example and the second example are explained here, otherwise reference is made to the embodiments given above. Here, a bolt 26 having a locking ring 27 is used as the second connecting element 20, and the additional clamping force 22 is applied by a spring element 28, here a disc spring 29.

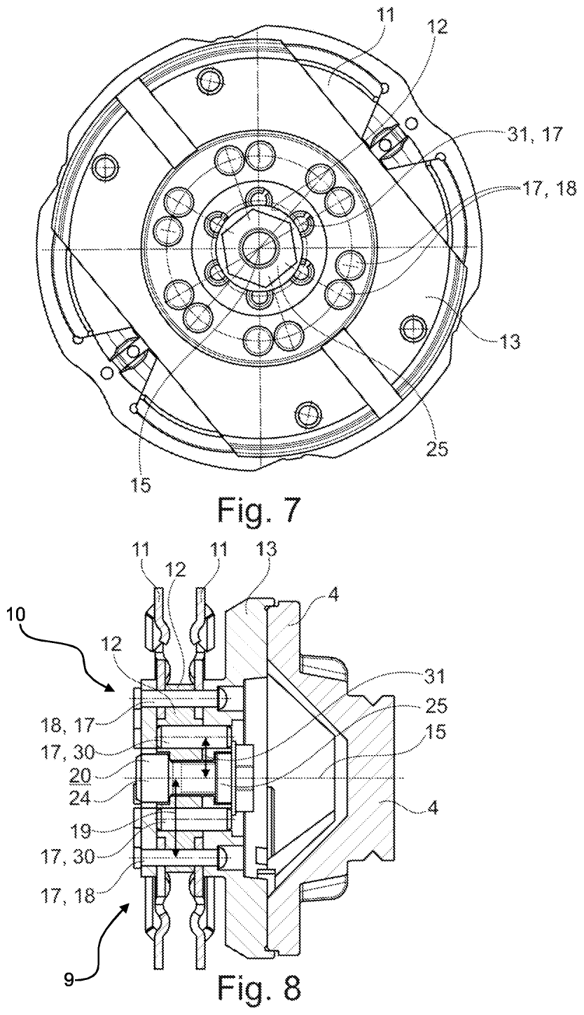

FIGS. 7 and 8 show a fourth example of a torsional vibration damper arrangement 9, on the one hand as a top view without a mounted connecting shaft (FIG. 7) and on the other hand as a sectional view with a mounted connecting shaft 4 (FIG. 8). The two figures are jointly described below. In order to avoid repetitions, only the differences to the first to third examples are described, otherwise reference is made to the embodiments given above. In addition to rivets 18 as first connecting elements 17 designed to be on a first radius 19, the fourth example has additional pin connections 30 as first connecting elements 17 formed on a second radius 31, also for transmitting torque from the first output flange 11 to the hub 12 and second output flange 13. Radially inside the hub 12, a screw 24 having a corresponding threaded nut 25 is designed as the second connecting element 20.

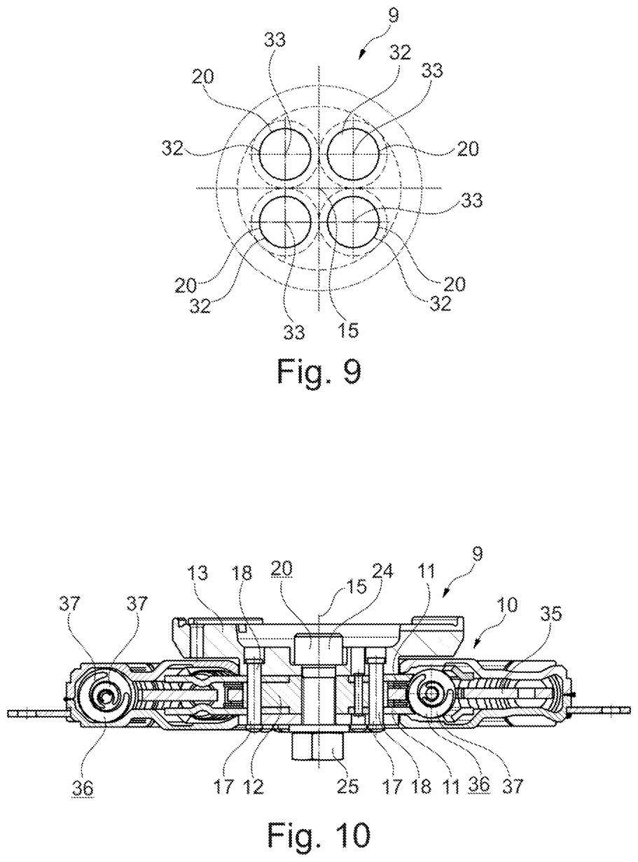

FIG. 9 shows, in a highly schematic fashion, a fifth example of a torsional vibration damper arrangement 9. In order to avoid repetitions, only the differences to the first to fourth examples are explained, otherwise reference is made to the embodiments given above. Here, instead of a single second connecting element 20, four second connecting elements 20 are designed to be radially within the hub 12. Each of the second connecting elements 20 is designed as a screw connection 32 including a respective pair of a screw and a thread, e.g., as a threaded nut. Each screw connection 32 has an axis 33 that is aligned to be parallel to the axis of rotation 15.

FIG. 10 shows another sectional view of the second example of a torsional vibration damper arrangement 9 having a torsional vibration damper 10. In order to avoid repetitions, reference is made to the description for the first to fifth examples; only the differences are explained here. FIG. 10 shows further details of the torsional vibration damper 9. In addition to the first output flanges 11 and the hub 12, FIG. 10 also shows an input flange 35 of the torsional vibration damper 9, via which it can be connected to a crankshaft of the internal combustion engine. The input flange 35 and the first output flange 11 are rotatable relative to one another against the action of a plurality of spring devices 36 to dampen torsional vibrations. Each spring device 36 includes at least one spring, in particular a compression spring, e.g., at least one bow spring 37.

The torsional vibration damper arrangement 9 proposed here includes a torsional vibration damper 10, which can be connected on the output side to a shaft, for example a connecting shaft 4, via a lateral second output flange 13. By means of a second connecting means 20 radially inside the hub 12, an additional clamping force 22 is generated which counteracts an additional force 16 caused by a moment M acting on the second output flange 13 through the connecting shaft 4 due to an axial and/or angular offset and can stress, damage and possibly destroy the first connecting means 17 by which the hub 12 is connected to the second output flange 13 and the at least one first output flange 13 of the torsional vibration damper 10. This eliminates the need for a cardan shaft in installation situations where an internal combustion engine is designed to be spatially separated from a transmission.

### REFERENCE NUMERALS

1 Motor vehicle
2 internal combustion engine
3 Clutch
4 Connecting shaft
5 Transmission input shaft
6 Transmission
7 Crankshaft
8 Chassis
9 Torsional vibration damper arrangement
10 Torsional vibration damper
11 First output flange
12 Hub
13 Second output flange
14 Connecting means
15 Axis of rotation
16 Additional force
17 First connecting element
18 Rivet
19 First radius
20 Second connecting element
21 Screw
22 Additional clamping force
23 Screw
24 Screw
25 Threaded nut
26 Bolt
27 Securing ring
28 Spring element
29 Disc spring
30 Pin connection
31 Second radius
32 Screw connection
33 Axis
34 Thread
35 Input flange
36 Spring device
37 Bow spring
38 Largest inner radius

What is claimed is:

1. A torsional vibration damper arrangement for use in a drive train of a motor vehicle, including a torsional vibration damper having an input flange and at least one first output flange, which can be rotated relative to one another about an axis of rotation against a plurality of spring devices, the plurality of spring devices including at least one bow spring, the at least one first output flange being connected via a hub to a second output flange for torque transmission to a further component in a rotationally fixed manner, the at least one first output flange, the hub and the second output flange being connected in a form-fitting or force-fitting manner by at least one first connecting element, which lies on at least one first radius with respect to the axis of rotation, wherein at least one second connecting element is designed which connects the hub to the second output flange in a force-fitting or form-fitting manner, wherein the second connecting element is designed to be at least partially radially inside the hub.

2. The torsional vibration damper arrangement according to claim 1, wherein the second connecting element is aligned to be flush with the axis of rotation.

3. The torsional vibration damper arrangement according to claim 1, wherein the hub has a largest inner diameter and the second connecting element extends radially within said largest inner diameter.

4. The torsional vibration damper arrangement of claim 1, wherein multiple second connecting elements are designed.

5. The torsional vibration damper arrangement of claim 1, wherein the second connecting element includes a screw and a thread in the second output flange.

6. The torsional vibration damper arrangement of claim 1, wherein the second connecting element includes a screw and a threaded nut.

7. The torsional vibration damper arrangement of claim 1, wherein the second connecting element includes a spring element for applying an additional clamping force.

8. The torsional vibration damper arrangement of claim 1, wherein the second connecting element includes a bolt, a locking ring, and a spring element for applying an additional clamping force.

9. The torsional vibration damper arrangement of claim 7, wherein the spring element includes a disc spring.

10. A motor vehicle including a connecting shaft and the torsional vibration damper arrangement of claim 1, wherein the second output flange of the torsional vibration damper arrangement is connected to the connecting shaft in a rotationally fixed manner.

11. A torsional vibration damper arrangement for a drive train of a motor vehicle, comprising:
a torsional vibration damper comprising:
an input flange; and
a first output flange, rotatable relative to the input flange about an axis of rotation against a spring device;
a second output flange;
a hub
a first connecting element lying on a first radius relative to the axis of rotation, the first connecting element connecting the first output flange, the second output flange, and the hub in rotationally fixed and form-fitting or force-fitting manner for torque transmission to a further component; and
a second connecting element disposed at least partially radially inside the hub and connecting the hub to the second output flange in a force-fitting or form-fitting manner.

12. The torsional vibration damper arrangement according to claim 11, wherein the second connecting element is aligned to be flush with the axis of rotation.

13. The torsional vibration damper arrangement according to claim 11, wherein the hub has a largest inner diameter and the second connecting element extends radially within the largest inner diameter.

14. The torsional vibration damper arrangement of claim 11, further comprising multiple second connecting elements.

15. The torsional vibration damper arrangement of claim 11, wherein:
the second output flange comprises a thread; and
the second connecting element comprises a screw threaded into the thread.

16. The torsional vibration damper arrangement of claim 11, wherein the second connecting element comprises a screw and a threaded nut.

17. The torsional vibration damper arrangement of claim 11, wherein the second connecting element comprises a spring element for applying an additional clamping force.

18. The torsional vibration damper arrangement of claim 17, wherein the second connecting element further comprises a bolt and a locking ring.

19. The torsional vibration damper arrangement of claim 18, wherein the spring element is a disc spring.

20. A motor vehicle comprising:
the torsional vibration damper arrangement of claim 11; and
a connecting shaft connected to the second output flange in a rotationally fixed manner.
